(19) United States
(12) Patent Application Publication
(10) Pub. No.: US 2011/0311787 A1
(43) Pub. Date: Dec. 22, 2011

(54) DECOMPOSABLE COMPOSITE WOOD SHEETS

(75) Inventor: Peo Akesson, Boulder, CO (US)

(73) Assignee: SUSTAINABLE CARDS, LLC, Boulder, CO (US)

(21) Appl. No.: 12/819,651

(22) Filed: Jun. 21, 2010

(51) Int. Cl. B32B 3/10; B32B 21/04; B32B 27/30; B32B 37/12; B32B 37/00; B32B 37/02; B32B 38/14; B32B 21/14; B32B 27/36

(52) U.S. Cl. 428/195.1; 428/411.1; 428/535; 428/500; 428/480; 156/60; 156/277; 156/163

(57) ABSTRACT

Various embodiments of decomposable composite sheets and manufacturing methods thereof are described. In one embodiment, the sheet includes an organic substrate and a first layer of a substantially organic backer that is securely affixed to a first side of the substrate. Other embodiments can include a second layer of a substantially organic backer that is securely affixed to a second side of the substrate, and/or one or more layers of thin-film overlay.

### CROSS-REFERENCE TO RELATED APPLICATIONS

This application is related to U.S. patent application Ser. No. 12/500,276, filed on Jul. 9, 2009, and entitled “Decomposable Information Carrier” and to U.S. patent application Ser. No. 12/686,006, filed on Jan. 12, 2010, and entitled “Hybrid Card.” The content of these applications is incorporated herein by reference in its entirety.

### BACKGROUND

The various embodiments described herein relate to decomposable composite wood sheets. Over the past decades, various types of plastics have replaced many traditional materials in a vast range of products and applications. Some examples include furniture and accessories, appliances, packaging materials, disposable cups, plates and cutlery, eyeglasses and contact lenses, windows, bags, clothing and fabrics, medical and dental implants, aerospace and space moldings, credit cards, badges, keys, toys, etc.

While these plastic products often are more economical to manufacture than their corresponding counterparts, they tend to have a higher human and environmental cost. For example, pure plastics generally have low toxicity in their finished state, but they often contain a variety of toxic additives that increase the pliability of the plastic. These additives can also leak out, for example in contact with food, and interfere with hormone functions in humans. Some are also suspected human carcinogens. Moreover, while the finished plastic may be non-toxic, monomers used in its manufacture may be toxic and small amounts of these monomers may remain trapped in the finished product.

Plastics are also durable and degrade very slowly. Since the 1950's, one billion tons of plastic have been discarded and may persist for hundreds or even thousands of years. In some cases, burning plastics can release toxic fumes. For example, burning the plastic polyvinyl chloride (PVC) may create dioxin. Furthermore, the manufacturing of plastics often creates large quantities of chemical pollutants. For at least these reasons, it would be desirable to find alternatives to plastics that are more environmentally friendly and less toxic.

### SUMMARY

The various embodiments described herein provide a decomposable and environmentally friendly alternative material to conventional plastics, which includes mostly organic matter and can be degraded through mechanisms such as UV-radiation, composting, aerobic or anaerobic degradation. The material can be used in a variety of applications where plastics are being used today, as will be seen in the following description.

In general, in one aspect, various embodiments of the invention relate to a decomposable composite sheet. The decomposable sheet includes an organic substrate; and a first layer of a substantially organic backer that is securely affixed to a first side of the substrate.

Various embodiments can include one or more of the following features. The sheet can include a second layer of a substantially organic backer that is securely affixed to a second side of the substrate. The sheet can include a first layer of thin-film overlay that is attached to the first layer of backer and a second layer of thin-film overlay that is attached to the organic substrate. The sheet can include a first layer of thin-film overlay that is attached to the first layer of backer and a second layer of thin-film overlay that is attached to the second layer of backer. The first layer of backer and the second layer of backer can be made of the same material. The first layer of thin-film overlay and the second layer of thin-film overlay can be made of the same material. The organic substrate can be made of wood and the first layer of backer can be made of a long fibrous cellulose material. The wood can be, for example, birch, pine, ash, beech, spruce or aspen. The first layer of backer can be affixed to the substrate by means of an adhesive pre-applied to the first layer of backer. The first layer of backer can include admixed synthetic fibers and a latex binder. The first and second layers of thin-film can be made of a material, such as Poly Vinyl Chloride, Bio-Poly Vinyl Chloride, Polythylene Terephthalate, Polyactic Acid, or various types of eco-friendly plastics. The sheet can include various graphics printed on a surface of the sheet. The sheet can be used to manufacture, for example, cards, signs, cutlery or plates.

In general, in one aspect, various methods are provided for making a decomposable composite sheet. A planar sheet of an organic substrate is provided. A first sheet of substantially organic backer is affixed to a first side of the substrate.

Various embodiments can include one or more of the following features. A second sheet of substantially organic backer can be affixed to a second side of the substrate, opposite to the first side. A first thin-film overlay can be applied to the first sheet of backer, and a second thin-film overlay can be applied to the organic substrate. A first thin-film overlay can be applied to the first sheet of backer, and a second thin-film overlay can be applied to the second sheet of backer.

Affixing the first sheet of backer to the substrate can include applying an adhesive to one or more of the first sheet of backer and the substrate, placing the first sheet of backer on the first side of the substrate, and applying heat and pressure to the first sheet of backer and the substrate to cause the adhesive to form a bond between the substrate and the first sheets of backer. The heat can be in the range of approximately 100 to 150 degrees Celsius, and the pressure can be in the range of approximately 10 to 30 kg/cm². One or more of a bar code, a magnetic strip, a smartchip, and a radio frequency identification (RFID) device can be to the sheet. Text and/or other types of graphics can be printed on the sheet. The substrate and affixed first backer can be flexed in a flexer.

The various embodiments can include one or more of the following advantages. An environmentally friendly material, which can be used as an alternative to conventional plastics in many applications, is provided. The material, which includes mostly organic matter and can be degraded through one or more of UV-radiation, composting, aerobic degradation or anaerobic degradation (i.e., the material decomposes). The decomposability of the material reduces harmful landfill waste. The material has similar features to many types of conventional plastics in terms of strength and flexibility. The details of one or more embodiments are set forth in the accompanying drawings and the description below. Other features and advantages will be apparent from the description and drawings, and from the claims.

### DESCRIPTION OF DRAWINGS

FIG. 1 shows a side view of a sheet (100), in accordance with one embodiment.

FIG. 1A shows a process (1000) for manufacturing a sheet (100), in accordance with one embodiment.

FIG. 2 shows a side view of a sheet (200), in accordance with one embodiment.

FIG. 2A shows a process (2000) for manufacturing a sheet (200), in accordance with one embodiment.

FIG. 3 shows a side view of a sheet (300), in accordance with one embodiment.

FIG. 3A shows a process (3000) for manufacturing a sheet (300), in accordance with one embodiment.

FIG. 4 shows a side view of a sheet (400), in accordance with one embodiment.

FIG. 4A shows a process (4000) for manufacturing a sheet (400), in accordance with one embodiment.

FIG. 5 shows a side view of a sheet (500), in accordance with one embodiment.

FIG. 5A shows a process (5000) for manufacturing a sheet (500), in accordance with one embodiment.

Like reference symbols in the various drawings indicate like elements.

### DETAILED DESCRIPTION

The various embodiments of the invention relate to materials that are composed of environmentally friendly components, while maintaining structural properties that are similar to conventional equivalent items manufactured from plastic. The material will be described herein by way of example and with respect to composite sheets. Some examples of possible use areas for the sheets and products that can be manufactured from the sheets will also be described below. However, as the skilled person realizes, this is a non-exclusive list and the techniques described herein can be applied to sheets that can be used for a variety of purposes.

### Embodiment 1

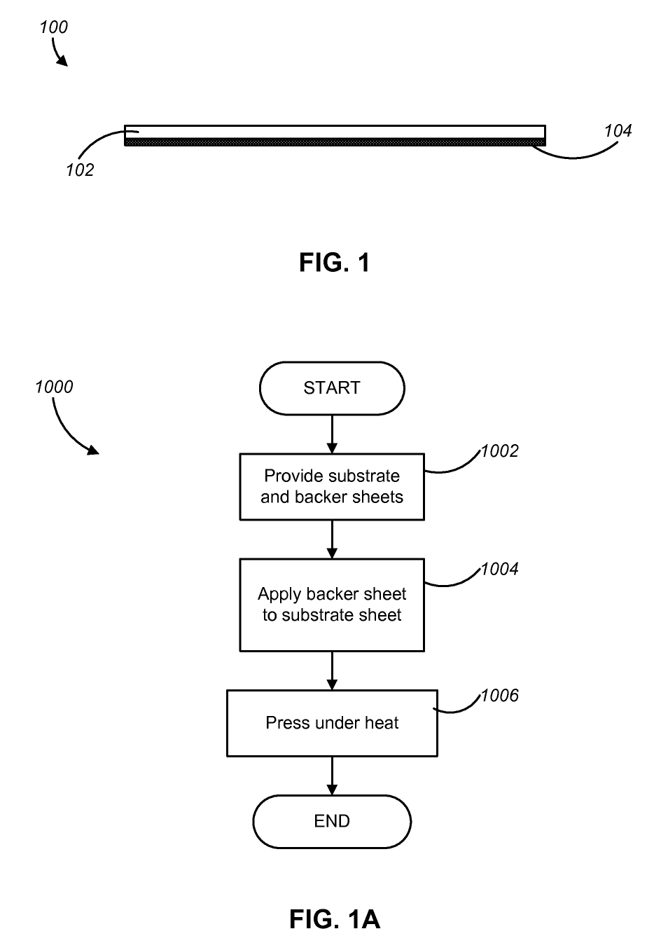

FIG. 1 shows a side view of a sheet (100), in accordance with one embodiment. The sheet (100) includes a main substrate (102) made of thin wood veneer, which is laminated with a transparent backer (104) made from long-fibrous cellulose on one side of the main substrate (102). The combination of wood veneer and cellulose backer improves the strength and flexibility of the sheet (100), making it comparable to conventional sheets made of PVC or similar materials. The thickness of the substrate (102) is approximately 0.10-1.50 mm and the thickness of the cellulose backer (104) is approximately 0.05-0.5 mm, thus resulting in a sheet (100) with a total thickness in the range of approximately 0.15-2.00 mm that can be used in a variety of applications where conventional plastics are used today.

Essentially any type of wood species that can be used to make veneer is suitable for use as the main substrate (102). Some examples of wood species that are particularly good include birch, pine, ash, beech, spruce, aspen, and so on. The major limiting factor for wood selection is the composition of the texture, alignment and appearance of the wood fibers, as this may in some applications affect the quality of the printing. The wood used for the main substrate (102) can be obtained from so-called “sustainable managed forests,” that is, forests that are managed based on environmentally, socially beneficial and economically viable management for present and future generations. Such forests are generally certified by some organization, such as the PEFC (Programme for the Endorsement of Forest Certification Methods), or the FSC (Forest Stewardship Council).

The backer (104) in this embodiment is made of long-fibrous cellulose. In one embodiment, the backer (104) is made of about 80% cellulose, with admixed synthetic fibers and a latex binder (or other adhesive with substantially the same properties) to bond the cellulose and synthetic fibers, thereby increasing the resilience of the backer (104). Different embodiments of the cellulose backer (104) can have varying degrees of transparency, from essentially opaque to essentially transparent. Typically the degree of transparency is in the range of about 80-90%, such that the structure of the main substrate (102) can be seen through the cellulose backer (104) and create an aesthetically pleasing appearance.

The substrate (102) and the cellulose backer (104) are laminated together by an adhesive. In some embodiments, the adhesive that is used for laminating the substrate (102) and the cellulose backer (104) can be pre-applied to the cellulose backer (104). In one embodiment the adhesive is a dried dispersion of Polyvinylacetate (PVAC). Important to note is that the formaldehyde content in this composition is far below any limits imposed by various organizations, thus minimizing any adverse environmental impact. It should however be realized that this is merely one example. Any type of environmentally friendly adhesive in minimum amounts and which fulfills the environmental standards, while having sufficient physical and chemical properties to make the substrate (102) and the cellulose backer (104) to adhere, can be used. Many such adhesives can be envisioned by those of ordinary skill in the art.

FIG. 1A shows a process (1000) for manufacturing a sheet (100), in accordance with one embodiment. As can be seen in FIG. 1A, the process starts by providing a substrate sheet (102) and a cellulose backer sheet (104) (step 1002). Next, the sheet of cellulose backer (104) is applied to the wood substrate (102) (step 1004). In one embodiment, the cellulose backer sheet (104) has an adhesive on the side of the cellulose backer (104) that is closest to the substrate sheet (102). After the cellulose backer sheet (104) has been applied, the substrate sheet (102), the cellulose backer sheet (104) and the substrate sheet (102) are pressed together under heat (step 1006). Typically the heat is in the range of approximately 100-150 degrees Celsius, and the pressure is in the range of approximately 10-30 kg/cm². The heat and pressure is typically applied for approximately 30 seconds to approximately 4 minutes, but all of these parameters can of course vary depending on one or more of the type of pressing device, adhesive, cellulose backer, substrate thickness and wood species that are being used in the process (1000). This causes the adhesive on the cellulose backer sheet (104) to melt, thus adhering the cellulose backer sheet (104) to the wood veneer (102). This ends the process (1000). The resulting sheets (100) can be used for a variety of applications, such as business cards, advertising signage and various types of other printed and non-printed materials. They can also be form pressed into disposable dinner plates and similar items.

### Embodiment 2

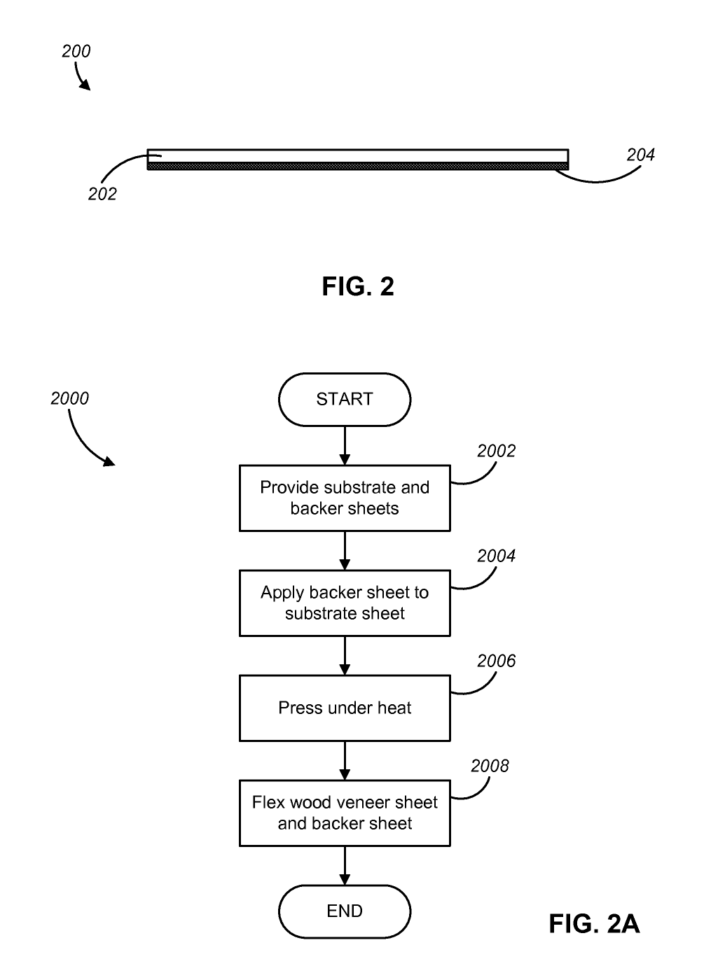

FIG. 2 shows a further embodiment of a sheet (200) that is essentially structurally identical to the sheet (100) shown in FIG. 1. However, the process (2000) for manufacturing the sheet (200) is slightly different, as will now be described with respect to FIG. 2A.

As can be seen in FIG. 2A, steps 2002 through 2006 are identical to steps 1002-1006, respectively, of FIG. 1A. The main difference between the sheet (200) and the sheet (100) described in the above embodiment is that a further step 2008 is added, in which the laminated substrate sheet (202) and backer sheet (204) are flexed in a flexer. Flexing is a technique that is used within many areas of the wood processing industry, and essentially means that the laminated sheet is pressed between two heavy rollers, similar to how fabric sheets, table cloths, etc. can be pressed between the two rollers of a mangle or wringer to flatten them. For the laminated substrate (202) and backer sheet (204), this causes the fibers in the substrate (202) to break, thus giving the substrate (202) more flexibility along the grain direction and thereby reducing brittleness and improving the durability of the sheet (200), so that it can be used in applications where more flexibility is required compared to the sheet described above with respect to FIG. 1.

### Embodiment 3

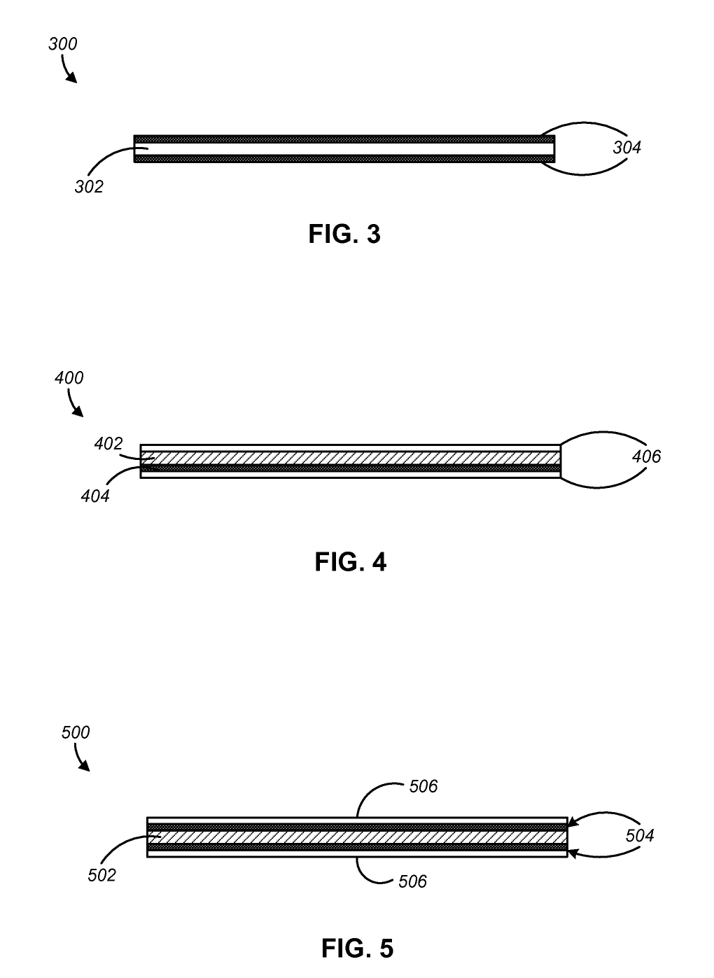

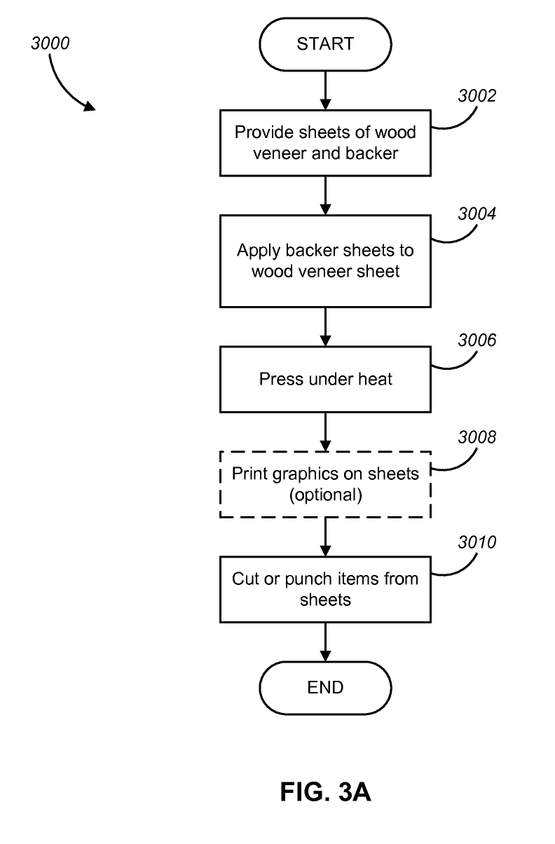

FIG. 3 shows a side view of a sheet (300), in accordance with one embodiment. Similar to what has been described above, the sheet (300) includes a main substrate (302) made of thin wood veneer. However, this embodiment has a transparent backer (304) made from long-fibrous cellulose laminated on either side of the main substrate (302). The combination of a wood veneer substrate (302) and cellulose backers (304) on either side still improves the strength and flexibility of the sheet (300). The dimensions and materials used for the substrate (302) and backer (304) are essentially the same as the dimensions and materials described above with respect to Embodiments 1 and 2.

FIG. 3A shows a process (3000) for manufacturing a sheet (300), in accordance with one embodiment. As can be seen in FIG. 3A, the process starts by providing one sheet of wood veneer (302) and two sheets of cellulose backer (304) (step 3002). Next, the two sheets of cellulose backer (304) are applied to the wood veneer (302) (step 3004). In one embodiment, the two cellulose backer sheets (304) have an adhesive on the respective sides of the cellulose backers (304) that face the wood substrate (302). After the cellulose backer sheets (304) have been applied, the wood substrate (302) and the two cellulose backer sheets (304) are pressed together under heat (step 3006), similar to what was described above for the embodiment with a single cellulose backer sheet (104). This causes the adhesive on the cellulose backers (304) to melt, thus adhering the two sheets of cellulose backer (304) to the respective sides of the wood substrate (302).

Next, optionally, graphics are printed on the sheets if so desired (optional step 3008). This can for example be useful if the sheet (300) is to be used for various printed articles, such as signs or various graphical designs that can be used for example for in-store advertising, do not disturb signs in hotels, and so on. There is a variety of printing techniques that can be used for printing graphics on the sheets. Some examples include water and waterless offset printing, screen printing, ink jet printing or laser printing, just to mention a few techniques. Other types of printing include retransfer printing (for example, as used by Artemis Solutions Group of Freeland, Wash.), thermal transfer printing (http://en.wikipedia.org/wiki/Thermal_transfer_printer), drop on demand ink jet printing (as used by Matthew's Marking Products of Pittsburgh, Pa.) and CO2 laser engraving (as described in http://en.wikipedia.org/wiki/Laser_engraving). All these printing techniques ought to be familiar to people having ordinary skill in the printing art.

Finally, the items are cut or punched from the sheets in their final geometrical shape (step 3010), which ends the process (3000). As an alternative to printing the graphics on the sheets in step 3008, the printing can instead be done after the individual items have been cut or punched out in step 3010. This is often referred to as “single printing” or “one-up,” and is a process well known to those of ordinary skill in the art. In some embodiments, after the items have been made, they can be coded in conventional manner to store account information, value information, personal information, key code information, and so on, as is well known to those of ordinary skill in the art. For example, RFID (Radio Frequency Identification) chips, magnet strips, barcodes, numbers, etc. can be provided, and can in some cases be concealed by a “scratch-off” layer, similar to what is used in lottery tickets, and so on.

### Embodiment 4

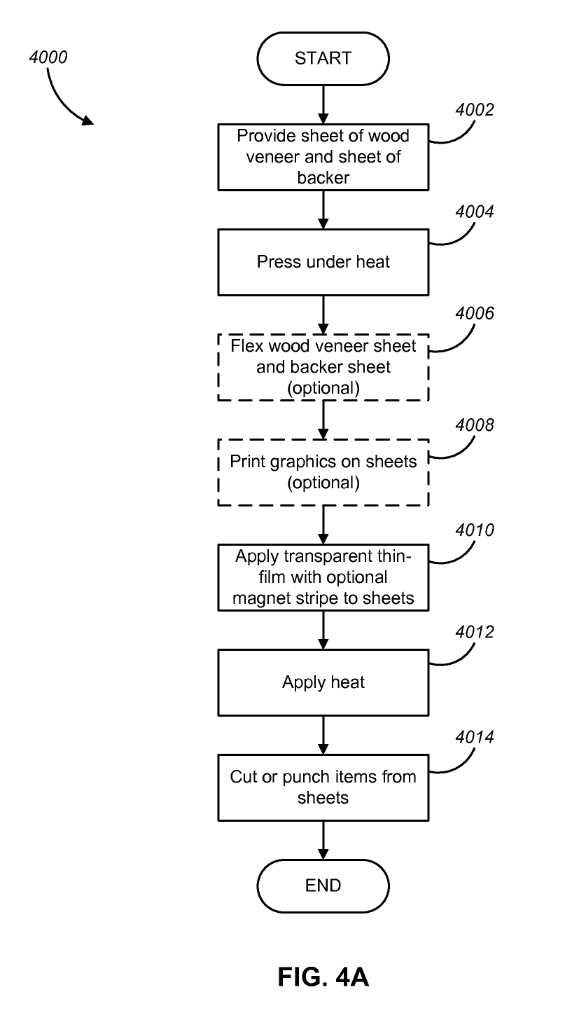

FIG. 4 shows a side view of a sheet, in accordance with another embodiment. Similar to the sheet described with reference to FIG. 1, the sheet (400) includes a main substrate (402) made of thin wood veneer, which is laminated with a single backer (404) made from long-fibrous cellulose. In addition, the sheet (400) is coated with a thin-film overlay (406) to create a durable and smooth coating. The thin-film overlay (406) can be made from many different substances, such as, PVC, Bio-PVC, PET-G (i.e., Polyester) or any other type of “Eco-friendly Plastic” that meets the required specifications. One category of plastics that meets such requirements is so-called Bioplastics. Bioplastics, which are also referred to as “Organic Plastics” are plastics that are derived from renewable biomass sources, such as vegetable oil, corn starch, pea starch or microbiota, for example, rather than fossil-fuel based plastics which are derived from petroleum. Most bioplastics exhibit various degrees of biodegradability. Some examples of bioplastics include starch based plastics, Polylactic acid (PLA) plastics, Poly-3-hydroxybutyrate (PHB) plastics, Polyamide 11 (PA 11) plastics, Bio-derived polyethylene plastics, and genetically modified (GM) bioplastics. Further details about these plastics can be found at, for example, http://en.wikipedia.org/wiki/Bioplastic and http://www.european-bioplastics.org/

The sheet (400) can be used in any conventional application where plastic sheets are used today and where a smooth and water-resistant surface is needed, such as outdoor signage, for example. While these sheets (400) may show slightly worse decomposing characteristics than the above-described sheets, due to the use of the thin-film overlay (406), the sheet (400) is still significantly more environmentally friendly compared to conventional plastic sheets that are used today in similar applications.

FIG. 4A shows a process (4000) for manufacturing a sheet (400), in accordance with one embodiment. The process (4000) starts by providing one sheet of wood veneer (402) and one sheet of cellulose backer (404) (step 4002). The wood veneer (402) and the cellulose backer sheet (404) are then pressed together under heat (step 4004), using essentially the same parameters that were described above, which causes them to be laminated together.

After pressing the wood veneer (402) and the cellulose backer sheet (404), the wood veneer (402) and cellulose backer sheet (404) are then optionally flexed in a flexer (step 4006). As described above, the flexing causes the fibers in the wood veneer (402) to break, thereby giving the wood veneer greater flexibility properties in the direction of the wood grain. If flexing were not applied, the sheets (400) may be more brittle in the direction along the wood grain and potentially crack or even break when used in certain applications.

Next, optionally, graphics are printed on the sheets if so desired (step 4006), using the techniques described above and a thin-film overlay (406) is applied to the sheets (step 4010). Next, heat is applied again (step 4012) to cause the thin-film overlay (406) to melt and adhere to the wood substrate (402) and the cellulose backer (404), respectively. Finally, items are cut from the sheets in their final geometrical shape (step 4014), which ends the process (4000). In the event no optional graphics was included onto the sheets in step 4006, printing of optional graphics on the items can be done after the manufacturing process (4000) is completed, using so-called single printing or one-up a process well known to those of ordinary skill in the art.

### Embodiment 5

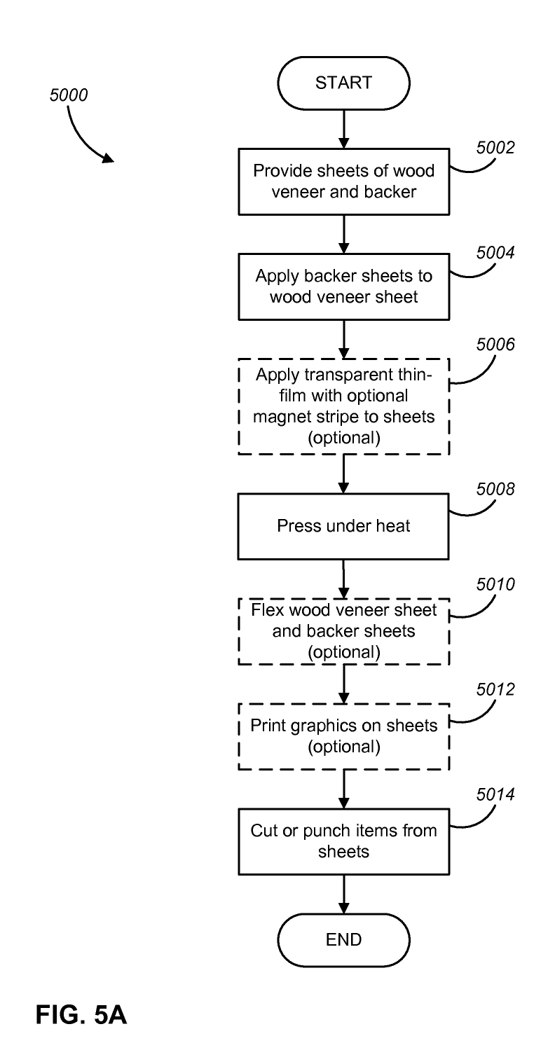

FIG. 5 shows a side view of a sheet (500), in accordance with one embodiment. The sheet (500) includes a main substrate (502) made of thin wood veneer, which is laminated with a transparent backer (504) made from long-fibrous cellulose on either side of the main substrate (502). Attached to the backers is a thin-film plastic layer (506). The combination of wood veneer, cellulose backer, and thin-film plastic improves the strength and flexibility of the sheet (500), making it comparable to conventional sheets made of PVC or similar materials. The thickness and smoothness of the sheet (500) makes the sheets (400) suitable for use in essentially any conventional application where plastic sheets are used today.

FIG. 5A shows a process (5000) for manufacturing a sheet (500), in accordance with one embodiment. As can be seen in FIG. 5A, the process (5000) starts by providing one sheet of wood veneer (502) and two sheets of cellulose backer (504) (step 5002). The sheet of the cellulose backer (504) that is to be adhered to the back of the sheet of wood veneer (502) can optionally have a magnet strip or RFID transmitting device included onto the cellulose backer (504), for example, if the sheets are to be used to manufacture keycards, gift cards, hotel keys, and the like. This is typically referred to as the magnet strip or RFID transmitting device being flush mounted or pre-applied.

Next, the two sheets of cellulose backer (504) (with or without the RFID transmitting device and/or magnet strip incorporated) are applied to the wood veneer (502) (step 5004). In one embodiment, the cellulose backers (504) have an adhesive on the side of the respective cellulose backers (504) that faces the wood veneer (502).

After the cellulose backer sheets (504) have been applied, a thin-film overlay (506) can be optionally applied to each side of the sheets of wood and adhered backer (step 5010). If the sheet (500) is to be used for items that are equipped with a magnet strip, and no magnet strip was added to the cellulose backer (504), the magnet strip can instead be added as part of this step by melting the magnet strip into the thin-film (506) (i.e., flush mounted). The thin-film (506) can be made from many different substances, such as, PVC, Bio-PVC, PET-G (i.e., Polyester) PLA (Polyactic Acid) or any other type of substances, such as the bioplastics described above, that comply with required standards, as is well-known to those of ordinary skill in the art.

After the cellulose backer sheets (504) and the optional thin-film overlays (506) have been applied in steps 5004 and 5006, the assembly is pressed together under heat (step 5008). Typically the heat is in the range of approximately 100-150 degrees Celsius, and the pressure is in the range of approximately 10-30 kg/cm². The heat and pressure is typically applied for approximately 30 seconds to approximately 4 minutes, but as the skilled person realizes, these are just general guidelines. All of these parameters can of course vary depending on one or more of the type of pressing device, adhesive, cellulose backer, veneer thickness and wood species, etc., that are being used in the process (5000). This causes the adhesive on the cellulose backers (504) to melt, thus adhering the two sheets of cellulose backer (504) to the respective sides of the wood veneer (502). Similarly, if step 5006 was conducted and plastic overlays (506) were applied, these will also melt and adhere to the two sheets of cellulose backer (504).

Next, in some embodiments, an optional step 5010 takes place, where the wood veneer sheet (502) with the adhered cellulose backers (504) and optional plastic films (506) are flexed in a flexer. As was described above, the flexing causes the fibers in the wood veneer (502) to break, thereby giving the wood veneer greater flexibility properties in the direction of the wood grain, which may be appropriate for certain applications.

In a further optional step 5012, graphics are printed on the sheets if so desired, using the techniques described above. In some embodiments, the printing can be done as a separate process on a thin film, for example, using the retransfer printing technique described above. The thin film can then be adhered to the cellulose backer (504) to provide graphics on the sheets (500) from which various items will be cut out, as will be described below.

Finally, items are cut or punched from the sheets (500) in their final geometrical shape (step 5014), which ends the process (5000). In the event no optional graphics was included onto the sheets in step 5012, printing of optional graphics can be done after all the sheet manufacturing process is completed, using so-called single printing or one-up a process well known to those of ordinary skill in the art. After the items have been cut out from the sheets (500), the items can be customized in various conventional manners using the magnet strip, RFID transmitter, or some kind of barcode, to store account information, value information, personal information, key code information, and so on, as is well known to those of ordinary skill in the art.

The various embodiments of the sheets (100, 200, 300, 400, 500) described above can be used in a variety of applications. For example, various types of cards, such as membership cards, gift cards, credit cards, hotel keys, etc. can be manufactured from the sheets. The sheets can also be used for other items, such as bookmarks, key rings, rulers, luggage tags, various types of signs, etc. The flexibility of the sheets also allow them to be bent to some extent, or to be form pressed into various items, such as plates, hangers, faceplates for light switches, lamp shades or other types of furniture accessories, etc. The variability in transparency of the overlay and the various printing mechanisms allow great flexibility in terms of how much of the wood grain will be visible to the casual observer and to what degree the items will have a “natural look.” If a “natural look” is not desired, i.e., no wood grain should be visible, the sheets can be screen printed so that the wood characteristics of the sheets are completely hidden from view and the sheets have a uniform color, similar to conventional plastic sheets. Essentially anything can be printed on the sheets, such as, a bank logo, a credit card company logo, a company logo, a product name or trademark, a store, a hotel logo, a holiday, a season, an occasion, a media format, e.g. characters, logos, scenes, or other illustrations or photographs related to at least one of a artist/performer, music, movie, television show, book, video game, etc. just to mention a few examples.

Some embodiments of the sheets, for example, the sheets (300, 400, 500) shown in FIGS. 3-5, lend themselves particularly well to making carrier cards that include break-off portions, such as SIM (Subscriber Identity Module) cards. SIM cards securely store information, such as unique serial number, internationally unique number of the mobile user (IMSI) used to identify a subscriber on wireless devices (such as mobile phones and computers), security authentication and ciphering information, temporary information related to the local network, and a list of the services the user has access to and two passwords (PIN for usual use and PUK for unlocking). The SIM card allows users to change wireless devices by simply removing the SIM card from one mobile phone and inserting it into another mobile phone or broadband telephony device.

SIM cards are currently available in three standard sizes. The first is the size of a credit card (85.60 mm×53.98 mm×0.76 mm). The second, most popular miniature version has the same thickness but a length of 25 mm and a width of 15 mm, and has one of its corners truncated (chamfered) to prevent misinsertion into the mobile device. The third version, known as the 3FF or micro-SIM, has dimensions of 15 mm×12 mm.

Most SIM cards of the two smaller sizes are supplied as a full-sized carrier card with the smaller SIM card held in place by a number of linking pieces, typically made of plastic. The SIM card can easily be broken off from the carrier card to be used in a device that uses the smaller SIM card. This arrangement is defined in ISO/IEC 7810 as ID-1/000 and allows for such a SIM card as supplied to be used in a device requiring a full-size card, or for a device requiring a mini-SIM card, suitable scorings manufactured along the outline of the mini-SIM card allow it to be cleanly broken out by hand.

By punching or cutting out holes with the appropriate size for SIM cards from the veneer (302, 402, 503), backers (304, 404, 504) and overlays (406, 506), respectively, prior to assembly of the wood sheets (300, 400, 500), it is possible to place multiple SIM cards in the punched out holes, that are held by linking pieces sandwiched between the various layers of veneer (302, 402, 503), backers (304, 404, 504) and overlays (406, 506), respectively, which allows easy break-off, similar to what is done in conventional carrier cards made of plastics. After adding the SIM cards to the wood sheets (300, 400, 500), credit card sized carrier-cards can be punched or cut from the wood sheets (300, 400, 500) and distributed to the end-users, using the same distribution mechanisms that are used for conventional plastic carrier cards.

While some exemplary measurements for the materials above have been described as approximately a 0.2-0.8 mm wood substrate and an approximately 0.15 mm backer, it should be realized that these are only approximate measurements that may vary. One way to create such a variation is to apply the sheets to pressure, which causes the finished sheet to have a smaller thickness, due to the porous nature of the wood substrate and the backer sheets. For example, by applying pressure a sheet such as the one described in “embodiment 3” above with a single layer of substrate and two layers of backer can be compressed from a total thickness of about 0.9 mm to about 0.4 mm.

The size of the sheets described above can vary, typically depending on the equipment that is used to manufacture the sheets, and the length of the logs from which the sheets are manufactured. To give a general idea of existing manufacturing capabilities, it is currently possible to manufacture sheets that have a size up to approximately 240 cm by 120 cm, but of course this may vary in future embodiments.

In many of the above manufacturing processes described with respect to FIGS. 1A, 2A, 3A, 4A and 5A, there have been steps described as pressing the backer sheet(s) and the wood substrate under heat. However, it should be realized that there are also embodiments where no heat may be needed. There are also many other materials that have similar properties to the ones described above that can be used to substitute one or more of the layers of the sheets. In some embodiments, for example, the thin-film overlay can be replaced with a UV curing, water-based or waterless lacquer, paint or ink, which possess different penetrating characteristics. The wood veneer is not required to have the exact thickness that is required for the sheet at the outset of the sheet manufacturing processes. Instead, a thicker wood substrate can be used, which is subsequently planed down to the desired thickness prior to adding the backers and thin-film overlay. The sheets of backer can be made of different materials that have different physical properties, which is also true for the sheets of thin-film overlay.

In addition to the above mentioned use areas, the sheets in accordance with the various embodiments can be used in a wide range of applications. Some include signs, restaurant menus, greeting cards, luggage tags, carriers (e.g. gift cards), card sleeves (as are often used in hotels to hold hotel keys), point to purchase displays (e.g. in-store signage), do not disturb signs (hanging as well as insert), outdoor signs, plant stakes, etc., just to mention a few other examples of usage areas.

Of course any type of conventional glue could also be used, but this would have adverse effects on the environmental impact. Likewise, of course, the wood does not have to be from a sustainably managed forest, but this would also have an adverse impact on the environment, and may not be desirable.

A number of embodiments have been described. Nevertheless, it will be understood that various modifications may be made without departing from the spirit and scope of the invention. Accordingly, other embodiments are within the scope of the following claims.

1. A decomposable composite sheet, comprising:
an organic substrate; and
a first layer of a substantially organic backer that is securely affixed to a first side of the substrate.

2. The sheet of claim 1, further comprising:
a second layer of a substantially organic backer that is securely affixed to a second side of the substrate.

3. The sheet of claim 1, further comprising:
a first layer of thin-film overlay that is attached to the first layer of backer; and
a second layer of thin-film overlay that is attached to the organic substrate.

4. The sheet of claim 2, further comprising:
a first layer of thin-film overlay that is attached to the first layer of backer; and
a second layer of thin-film overlay that is attached to the second layer of backer.

5. The sheet of claim 2, wherein the first layer of backer and the second layer of backer are made of a same material.

6. The sheet of claim 3, wherein the first layer of thin-film overlay and the second layer of thin-film overlay are made of a same material.

7. The sheet of claim 1, wherein the organic substrate is made of wood and the first layer of backer is made of a long fibrous cellulose material.

8. The sheet of claim 7, wherein the wood is selected from the group consisting of: birch, pine, ash, beech, spruce and aspen.

9. The sheet of claim 1, wherein the first layer of backer is affixed to the substrate by means of an adhesive pre-applied to the first layer of backer.

10. The sheet of claim 1, wherein the first layer of backer further comprises admixed synthetic fibers and a latex binder.

11. The sheet of claim 3, wherein the first and second layers of thin-film are made of a material selected from the group consisting of: Poly Vinyl Chloride, Bio-Poly Vinyl Chloride, Polythylene Terephthalate, Polyactic Acid, and bioplastics.

12. The sheet of claim 1, wherein the sheet includes various graphics printed on a surface of the sheet.

13. The sheet of claim 1, wherein the sheet is operable to be used in manufacture of one or more of: cards, signs, cutlery, plates, and furniture accessories.

14. A method for making a decomposable composite sheet, comprising:
providing a planar sheet of an organic substrate; and
affixing a first sheet of substantially organic backer to a first side of the substrate.

15. The method of claim 14, further comprising:
affixing a second sheet of substantially organic backer to a second side of the substrate, opposite to the first side.

16. The method of claim 14, further comprising:
applying a first thin-film overlay to the first sheet of backer; and
applying a second thin-film overlay to the organic substrate.

17. The method of claim 15, further comprising:
applying a first thin-film overlay to the first sheet of backer; and
applying a second thin-film overlay to the second sheet of backer.

18. The method of claim 14, wherein the substrate is made of wood veneer and the first sheet of backer is made of a long fibrous cellulose material.

19. The method of claim 14, wherein affixing the first sheet of backer to the substrate includes:
applying an adhesive to one or more of the first sheet of backer and the substrate;
placing the first sheet of backer on the first side of the substrate; and
applying heat and pressure to the first sheet of backer and the substrate to cause the adhesive to form a bond between the substrate and the first sheets of backer.

20. The method of claim 19, wherein the heat is in the range of approximately 100 to 150 degrees Celsius, and wherein the pressure is in the range of approximately 10 to 30 kg/cm².

21. The method of claim 14, wherein the first sheet of backer further includes a combination of synthetic fibers and a latex binder.

22. The method of claim 14, further comprising adding one or more of a bar code, a magnetic strip, a smartchip, and a radio frequency identification (RFID) device to the sheet.

23. The method of claim 14, further comprising printing one or more of text and graphics on the sheet.

24. The method of claim 14, further comprising:
flexing the substrate and affixed first backer.

25. The method of claim 16, wherein the first and second thin-film overlays are made of a material selected from the group consisting of: Poly Vinyl Chloride, Bio-Poly Vinyl Chloride, Polythylene Terephthalate, Polyactic Acid and bioplastics.
